(19) United States
(12) Patent Application Publication
(10) Pub. No.: US 2006/0046761 A1
(43) Pub. Date: Mar. 2, 2006

(54) Method and apparatus to customize a universal notifier

(75) Inventors: Craig G. Bishop, Boca Raton, FL (US); Timothy W. Heffield, Sunrise, FL (US); Jose E. Korneluk, Boynton Beach, FL (US)

Correspondence Address: POSZ LAW GROUP, PLC, 12040 SOUTH LAKES DRIVE, SUITE 101, RESTON, VA, 20191, US

(73) Assignee: MOTOROLA, INC.

(21) Appl. No.: 10/928,984

(22) Filed: Aug. 27, 2004

(51) Int. Cl. H04Q 7/00

(52) U.S. Cl. 455/519

(57) ABSTRACT

A universal notifier (115) is individualized with an appended custom tag so that users may recognize calls intended for them. When a call transmitted from a communication device (101), is received by a recipient communication device (103), the universal notifier, for example an existing private call receive tone, is generated, and a custom indicator is generated (117). The universal notifier, for example a well-known sound of the direct connect call (115), is thereby preserved, while adding a custom identifier that individual users can readily identify. Variations provide that the custom indicator can be further particularized to a specific call originator, to a specific recipient, to a group, or to a severity phone call such as a local emergency. Group calls with an associated custom indicator can be transmitted in a group call environment.

### FIELD OF THE INVENTION

The present invention relates in general to wireless communication units and wireless networks. More particularly, the present invention relates to a method and apparatus for individualizing a universal notifier with a custom indicator.

### BACKGROUND OF THE INVENTION

A universal notifier may be generated when, for example, a push-to-talk dispatch (direct connect) call is received on an integrated digital enhanced network communications device, such as a cellular phone. Such universal notifiers include, for example, well-known private call receive tone, such as for communications devices from Nextel Corporation. Other communications service and device providers may be associated with their own universal notifiers.

With this popularity, it may not be unusual to have many users with the same universal notifier in a particular area. It may be difficult for users to immediately discern whose unit is receiving a call, for example, when a direct connect call is received by one of these users having a communication device, for example, from Nextel corporation. The user typically must refer to the display of their unit to determine if they are being signaled. Indeed, many of the users in earshot of a universal notifier will reach for and check the display of their units to determine whether their unit that is receiving the call.

Therefore, to address the above described problems and other problems, what is needed is a method and apparatus for individualizing the universal notifier.

### BRIEF DESCRIPTION OF THE DRAWINGS

The accompanying figures, where like reference numerals refer to identical or functionally similar elements and which together with the detailed description below are incorporated in and form part of the specification, serve to further illustrate a preferred embodiment and to explain various principles and advantages in accordance with the present invention.

FIG. 1 is a block diagram illustrating exemplary simplified and representative devices for transmitting and receiving calls with a custom indicator in a direct connect environment, in accordance with various exemplary embodiments;

FIG. 2 is a block diagram illustrating exemplary simplified and representative devices for transmitting and receiving calls with various custom indicators, e.g., priority, severity or group call, in accordance with one or more embodiments;

FIG. 3 is a block diagram illustrating exemplary simplified and representative devices for transmitting and receiving calls with a group call indicator, in accordance with one or more embodiments;

FIG. 4 is a flow diagram illustrating an example selective dynamic group call utilizing selected custom indicators for individual recipients, in accordance with one or more embodiments;

FIG. 5 is a flow chart illustrating an exemplary procedure for transmitting an individualized call, in accordance with one or more embodiments;

FIG. 6 is a first portion of a flow chart illustrating an exemplary procedure for determining a custom indicator for a call to be transmitted, in accordance with one or more embodiments;

FIG. 7 is second portion of the flow chart of FIG. 6;

FIG. 8 is a flow chart illustrating an exemplary procedure for receiving an individualized call, in accordance with one or more embodiments;

FIG. 9 is a flow chart illustrating an exemplary procedure for determining a custom alert indicator for a received call, in accordance with one or more embodiments;

FIG. 10 is a flow chart illustrating an exemplary procedure for generating a custom alert indicator for a call in fixed network equipment (FNE), in accordance with one or more embodiments; and

FIG. 11 is a block diagram of an exemplary communication device in accordance with one or more embodiments.

### DETAILED DESCRIPTION OF THE PREFERRED EMBODIMENTS

In overview, the present disclosure concerns wireless communications devices or units, often referred to as communication units, such as cellular phone or two-way radios, pagers, walkie talkies, other wireless communication devices, and the like, associated with a communication system such as an Enterprise Network, a cellular Radio Access Network, a dispatch network, unit-to-unit communications, or the like. Such communication systems may further provide services such as voice and data communications services to the communication units. The term communication unit may be used interchangeably herein with subscriber unit, wireless subscriber unit, phone, wireless subscriber device or the like. Each of these terms denotes a device ordinarily associated with a user and typically a wireless mobile device that may be used with a dispatch network, a public network, for example in accordance with a service agreement, unit-to-unit, or within a private network such as an enterprise network.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that relational terms such as first and second, and the like, if any, are used solely to distinguish one from another entity, item, or action without necessarily requiring or implying any actual such relationship or order between such entities, items or actions.

Much of the inventive functionality and many of the inventive principles when implemented are best supported with or in software or integrated circuits (ICs), such as a processor or digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

The communication systems and communication units of particular interest are those providing or facilitating voice communications services or data messaging services over dispatch networks, such as talk-around dispatch systems, cellular wide area networks (WANs), such as conventional two way systems and devices, various cellular phone systems including analog and digital cellular, CDMA (code division multiple access) and variants thereof, Global System for Mobile communications (GSM), GPRS (General Packet Radio System), 2.5G and 3G systems such as UMTS (Universal Mobile Telecommunication Service) systems, Internet Protocol (IP) Wireless Wide Area Networks like 802.16, or 802.20, integrated digital enhanced networks, quadrature amplitude modulation systems (Quad QAM), unit-to-unit communications systems, and variants or evolutions thereof. Furthermore the wireless communication units or devices of interest may have short range wireless communications capability, or may be any type of a direct connect capable communication device.

Typically, the tone or other alert, referred to herein as a universal notifier, may be, for example, a push-to-talk tone or dispatch tone that may be intended to identify and/or may be associated with a service provider or manufacturer of the communication device. This universal notifier is generally not customizable, although certain devices allow the user to select at registration a particular one from several pre-defined universal notifiers stored in the communication device corresponding to the service provider.

A universal notifier is often generated when, for example, a private call, direct connect call, or page request, is received, for example, on an integrated digital enhanced network unit. One type of universal notifier may be referred to as a talk permission alert (e.g., push-to-talk tone or dispatch tone), which, for example, may notify the recipient and may inform the user that the channel may be clear to talk.

As another example, many integrated digital enhanced network units provided by or available from a company, such as Nextel Corporation, typically have the same pre-defined private call receive alert or tone. Units available from Nextel Corporation, for example, have a tone or alert that in one embodiment is the three tone sequence:
1.) 2300 Hz tone for 88 mS.
2.) 88 mS Silent
3.) 2300 Hz tone for 88 mS.
4.) 88 mS Silent
5.) 2300 Hz tone for 88 mS.

As further discussed herein, various inventive principles and combinations thereof are advantageously employed to individualize the push-to-talk tone or dispatch tone or similar notifiers that can be used by a large number of communications devices for similar indications.

One or more embodiments provide for generating the existing private call receive tone or other universal notifier, and appending the custom indicator afterward. The well-known sound or alert that signals, for example, the direct connect call, is thereby preserved, while adding a custom or individualized indicator that an individual user can readily identify.

The custom indicator could be, for example, a repetitive ring tone, a musical instrument digital interface (MIDI) file, a wave file, a voice recording, a particular vibratory alert pattern, and/or other unique indicator, or a combination of one or more of the foregoing.

Variations of the exemplary embodiments may be utilized. As a first example, a custom indicator that is unique to a given user or class of user can be used. Consider, for example, a user inside a restaurant or another busy area with multiple direct connect users. A unique recipient indicator may be appended to the standard private call receive tone, to notify a particular user of a private call. The recipient of such an individualized call, identified or individualized by both the universal indicator and the custom indicator, can readily identify by virtue of the custom indicator which call is theirs.

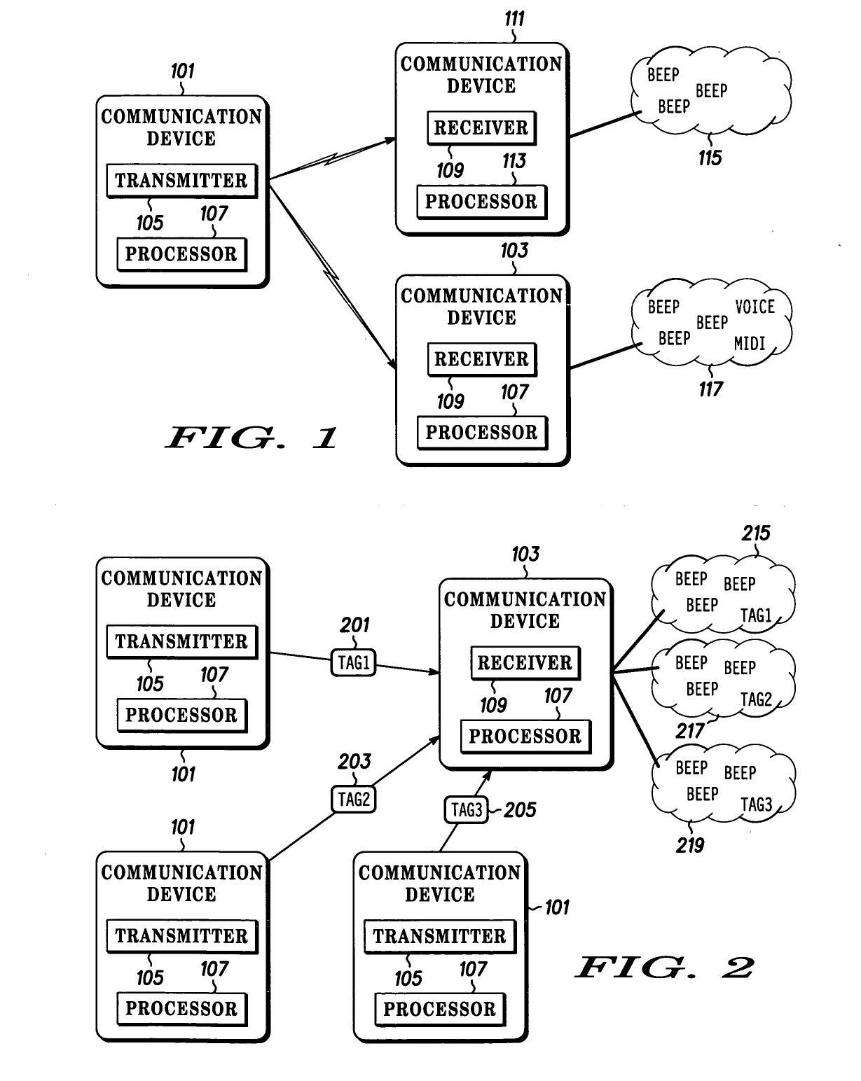

FIG. 1 provides a simplified illustration of transmitting and receiving a call, in a direct connect environment. In the present illustration, a dispatch network includes a transmitting communication device 101, e.g. a handset of phone, a first receiving communication device 103, and a second receiving communication device 111. The transmitting communication device 101 includes a transmitter 105, for transmitting the call; and a processor 107. The first receiving communication device 103 includes a receiver 109, and a processor 113; and the second receiving communication device 111 includes a receiver 109 and a processor 107. The transmitting communication device 101 initiates a direct connect call. The first receiving communication device 103 may be configured to receive a direct call and provide not only the universal notifier (depicted as BEEP BEEP BEEP), for example a private call receive tone or other alert common to multiple devices, for example devices from a same manufacturer or provider, but also the custom indicator 117, such as a MIDI and voice file or alert (depicted as MIDI, VOICE). The second receiving communication device 111, having a processor 109 with conventional software, merely generates the universal notifier 115 upon receipt of a direct call.

As a second example, a custom indicator corresponding to a priority of a call may be used. Such an indicator could be set based on the caller or group, e.g., to distinguish a direct connect call from a co-worker, management or a family member. As a third example, a custom indicator can be used to indicate the severity of the call. In this instance, the direct connect initiator or the system sets the severity, such as during a homeland security issue and/or national disaster.

FIG. 2 provides an illustration of transmitting and receiving calls with various custom indicators. This simplified example provides three transmitting communication devices 101, to illustrate examples of alternative custom indicators. One of the transmitting communication devices 101 initiates a direct connect call to the receiving communication device 103, where the user of the transmitting communication device may be identified as a family member by TAG 1 201 (associated with the call). Another of the transmitting communication devices 101 initiates a direct connect call to the receiving communication device 103, where the transmitting communication device may be identified as an employer by TAG 2 203 (associated with the call). In this example, the tag may be determined by the recipient or receiving device based on the caller identity or the group identity. The third of the transmitting communication devices 101 initiates a direct connect call that may be identified by TAG 3 205 (associated with the call) as being related to an emergency, homeland security issue, or national disaster. The calls are received at the receiving communication device 103, and each of the respective tags may be detected at the receiving communication device 103. When the receiving communication device 103 determines that the tag may be TAG 1, it may generate the direct connect call universal notifier plus the custom indicator corresponding to TAG 1 indicating a family member call 215. When the tag is TAG 2, the receiving communication device 103 can generate the direct connect call universal notifier plus the TAG 2 custom indicator indicating an employer initiated call 217. If the tag indicates TAG 3, the receiving communication device would generate the direct connect call universal notifier plus the TAG 3 custom indicator indicating a severity call (an emergency and/or high priority call) 219. The call severity indicator may have a louder volume or perhaps longer duration than normal.

The tag, e.g., TAG 1, TAG 2, TAG 3 associated with a particular call may comprise both an indication from the call itself, and the associated custom indicator that should be generated by the communication device receiving the call. The indication from the call itself, that is, that the call may be associated with a custom indicator, may be a part of the call, or may be deduced from the caller or the recipient identification. The custom indicator associated with the call, which may be generated by the communication device receiving the call, in some embodiments may be selected by the recipient at his/her own communication device, and/or may be selected by the call originator and/or Fixed Network Equipment (FNE). In a situation where the custom indicator is not selected at the recipient's communication device, the custom indicator may be transmitted to the recipient communication device as part of a separate communication, or as part of the call itself.

A fourth exemplary embodiment can allow the originator of a call in a group call to generate and send a unique custom indicator to all users in a call, to a selected user, or to as many users as desired. For example, if three people are in a group call, the originator of the call may send three individually unique tones to be used as custom indicators by the respective recipients.

For example, the custom indicator to be associated with a particular call may be sent over the air by the originator of the call. Considering the example of a group call, the call originator may generate a unique “tag” to be sent to each recipient in the group call. If three people are in a group call, the originator can send a unique tag to each recipient or only to selected recipients. Advantageously, the custom indicator may be specified at the time the call is placed, so that the call originator can send the same custom indicator for the group call to all recipients, or unique custom indicators to particular users, and combinations thereof.

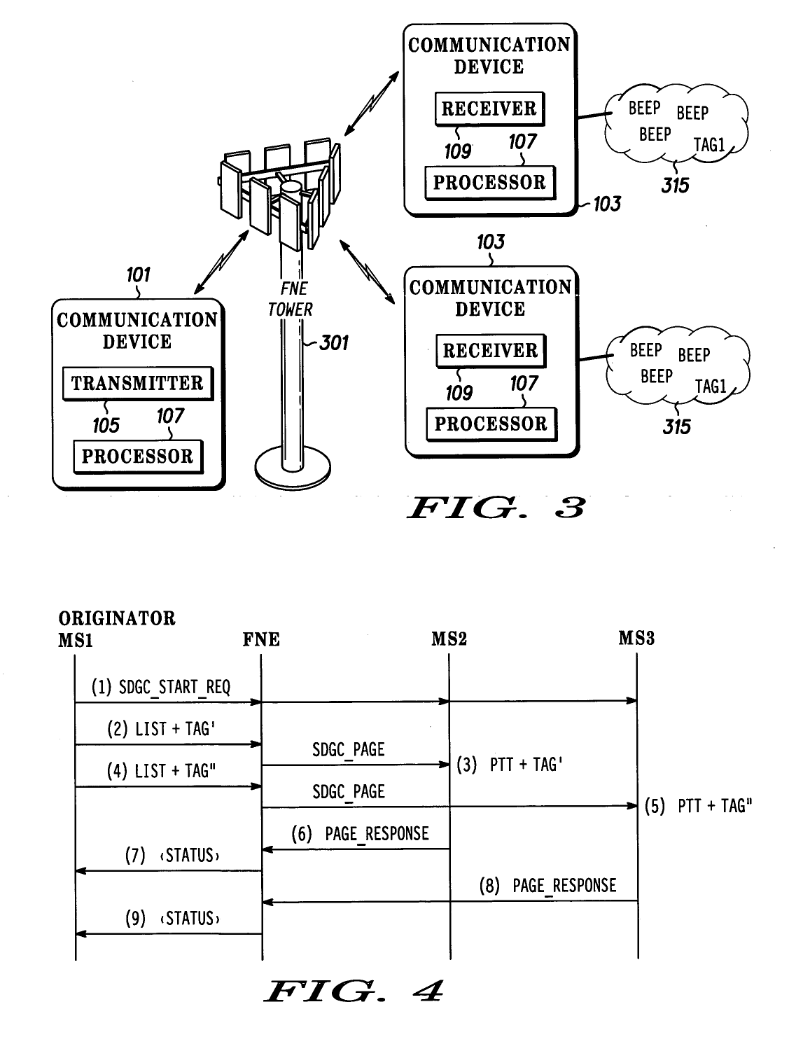

FIG. 3 provides an illustration of transmitting and receiving calls with a custom group call indicator. This exemplary embodiment illustrates a transmitting communication device 101, and two receiving communication devices 103. In this exemplary variation, a group call can be generated by the transmitting communication device 101, and directed to and intercepted by the fixed network equipment (FNE), represented by an FNE tower 301. The FNE may determine the members of the group and the group call indicator, and then generate the calls (associated with the group call indicator) to the receiving communication devices 103 that are members of the group. The receiving communication devices 103 would determine that the call is a group call, and determine the group call indicator, and then generate the universal call notifier plus the group call indicator 315.

This exemplary embodiment may be accomplished using, for example, a selective dynamic group call (SDGC) feature. Accordingly, the handset may upload, to the fixed network equipment (FNE), the private identifiers of every user in the group. This may be implemented, for example, via the same or similar mechanism as may be used to upload the voice and/or tag which may be delivered to the user upon paging.

Optionally, a communication device may provide a user with the ability to turn on or off the playing of custom indicators.

Reference is now made to FIG. 4, illustrating an example embodiment wherein the custom indicator can be generated by the sender and can be customized for individuals in the call. In this example, three mobile stations (MS1, MS2, MS3) are in a group call. The originator of the call, MS1, can send custom indicators within the group, such as unique tones or information corresponding to unique tones, that will be used by recipients for this group call. FIG. 4 provides an example of one or more embodiments, within a selective dynamic group call (SDGC) environment. Initially, an SDGC start call request is transmitted from MS1 to the FNE (1). MS1 can upload to the FNE the list of users in the group and corresponding custom indicator (LIST+TAG′) that will be used for those listed users within the group at (2), and the FNE may page the user(s) in the list (depicted as MS2) (3). Upon receipt of the page, the recipient MS2 can generate the universal notifier, e.g. a push-to-talk tone plus the custom indicator (depicted as PTT+TAG′). MS1 may upload a similar list and custom indicator (depicted as LIST+TAG″) for a second group at (4), and the FNE similarly can page the user(s) in the second list (shown as MS3), at (5). Again, the recipient MS3 would generate the universal notifier, e.g. a push-to-talk tone plus the custom indicator (depicted as PTT+TAG″). MS2 and MS3 can return page responses, (6), (8) to the FNE, which then return status reports (7), (9) to the call originator MS1. Hence, the recipients within the group can typically and readily determine whether their respective communication device is generating the alert, e.g. universal notifier plus custom indicator.

One or more embodiments provides for selectable custom indicators. Because the custom indicator can be specified at the time the call is placed, the call originator may send the same custom indicator to all users, send unique custom indicators to particular users, or combinations thereof.

Reference is now made to FIG. 5, where a flow chart of an exemplary procedure for transmitting an individualized call will be discussed and described. According to this example, a procedure 501 for transmitting an individualized call, i.e., a call that intended to include or correspond to a custom indicator, can be performed at the transmitting device initiating the call. The device would generate or initiate the call to be transmitted, at 503, in accordance with customary procedures. The device checks whether there is a custom indicator to be associated with the call at 505. A custom indicator may be associated with a call for reasons including for example the call may be a group call, the call may be a severity call, the call may be to a recipient who can be associated with a custom indicator or who has requested an individualized call, or based on a preference of the user of the device originating the call, etc. If there is a custom indicator to be associated with the call, then the device will associate the custom alert indicator with the call, 507. Optionally, the custom indicator, e.g., midi file, wave file, voice recording, etc., can be transmitted to the recipient at 511. Then, at 509, the call associated with the custom indicator will be transmitted. The call may be associated with the custom indicator in various ways, for example, by a bit or flag indicating that the call is individualized, a flag or indication corresponding to one of several different custom indicators, a flag indicating a location in a list of custom indicators, or by incorporation of the custom indicator into the call, etc. The procedure for transmitting an individualized call then ends at 513.

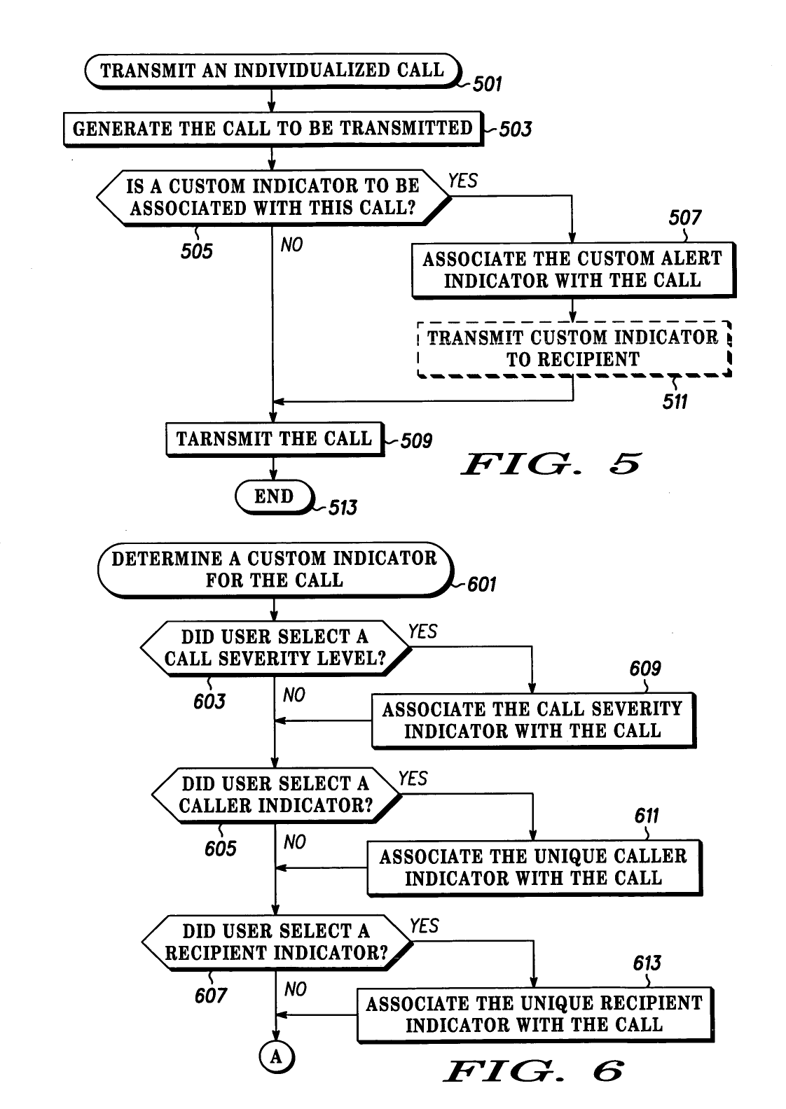

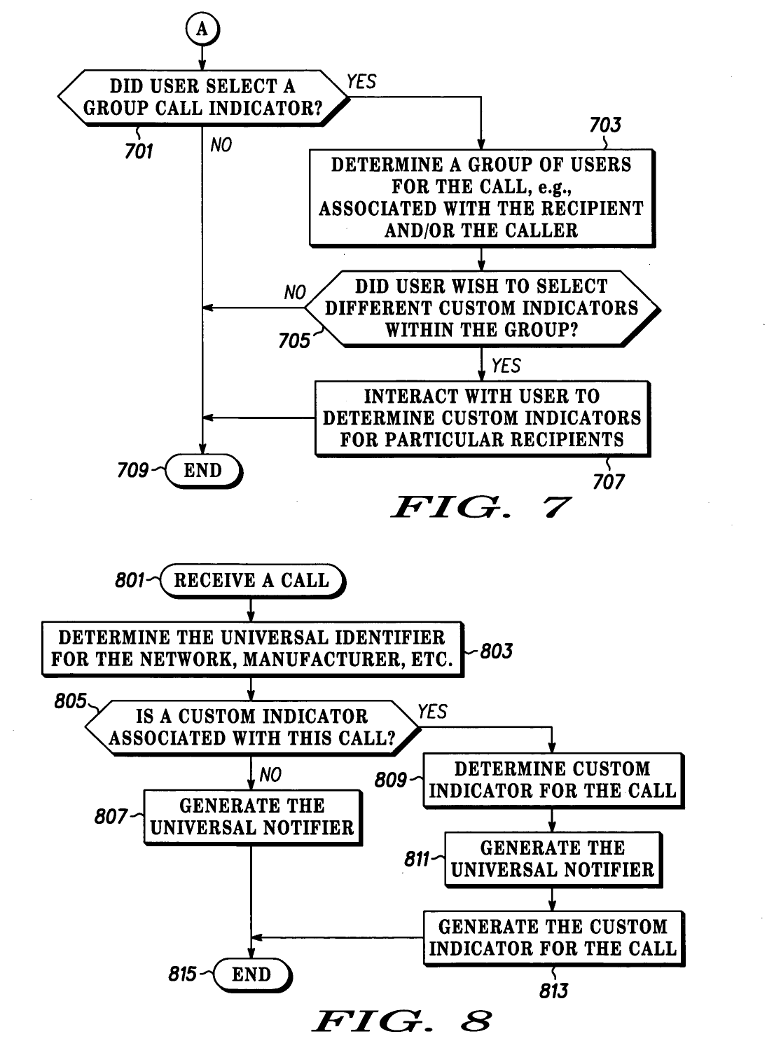

FIGS. 6 and 7 provide example flow charts for determining a custom indicator 601 that can be associated with the call. In this example, the transmitting device may determine whether the user selected a call severity level 603. If so, the device can associate the call severity indicator with the call 609. The transmitting device may determine whether the user selected a particular caller indicator 605. If so, the device would associate the unique caller indicator with the call 611. The transmitting device may determine whether the user selected a particular recipient indicator 607. If so, the device can associate the unique recipient indicator with the call 613. Also, the transmitting device may determine whether the user selected a group indicator for the call 701. If so, the device would determine a group of users for the call using a group call indicator associated with the group. For example, the group of users may be determined automatically by examining groups that include the recipient and/or the caller, 703. According to one or more embodiments, the device also may determine if the user wishes to select different custom indicators within the group, 705. If so, then at 707, the device can interact with the user to determine custom indicators to be used for particular recipients within a group call or otherwise assign custom indicators, etc. At 709, processing for selecting a custom indicator ends.

Reference is now made to FIG. 8, illustrating an example flow chart for a device receiving an individualized call, 801. The device initially receives a call 801, and determines the universal identifier for the network, manufacturer, services etc. 803, in accordance with known procedures. Then the device can determine whether a custom indicator should be associated with the received call 805. If so, the device can determine the custom indicator to be used for the received call, 809; generate the universal notifier 811, and then generate the custom indicator for the call 813. If there is no custom indicator at 805, the device will generate the universal notifier in accordance with standard practices 807. Processing for receiving a call then ends 815.

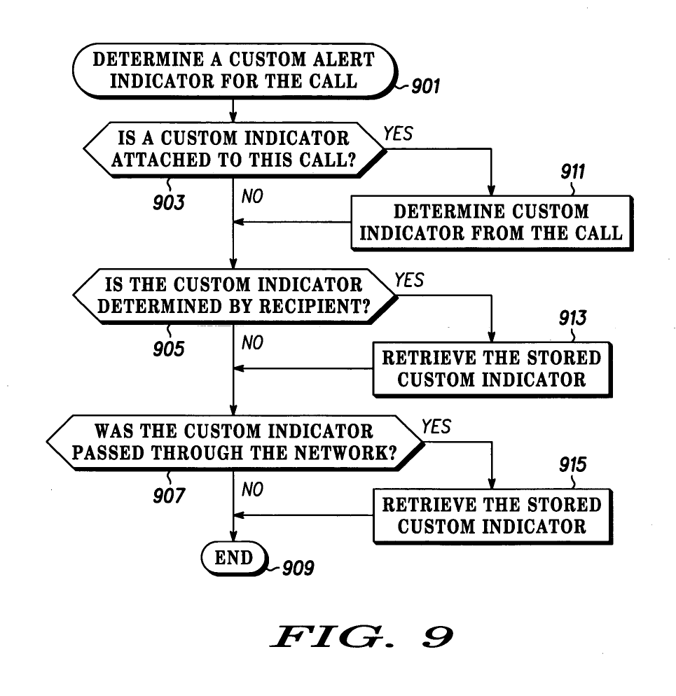

FIG. 9 illustrates an example flow chart for determining the custom alert indicator to be used for a particular call 901. To determine the proper custom indicator, the receiving device can determine whether a custom indicator is attached to or otherwise associated with or embedded in the call 903. If so, the device can obtain the custom indicator from the call 911. At 905, the device determines whether the custom indicator was selected or predetermined by the recipient. If so, at 913, the device can retrieve the stored custom indicator from internal memory. At 907, the device determines whether the custom indicator may have been passed through the network, e.g., in a prior call, and thus have been stored in the device. If so, the device can retrieve the stored custom indicator from internal memory 915. Processing for determining a custom indicator for the call ends at 909.

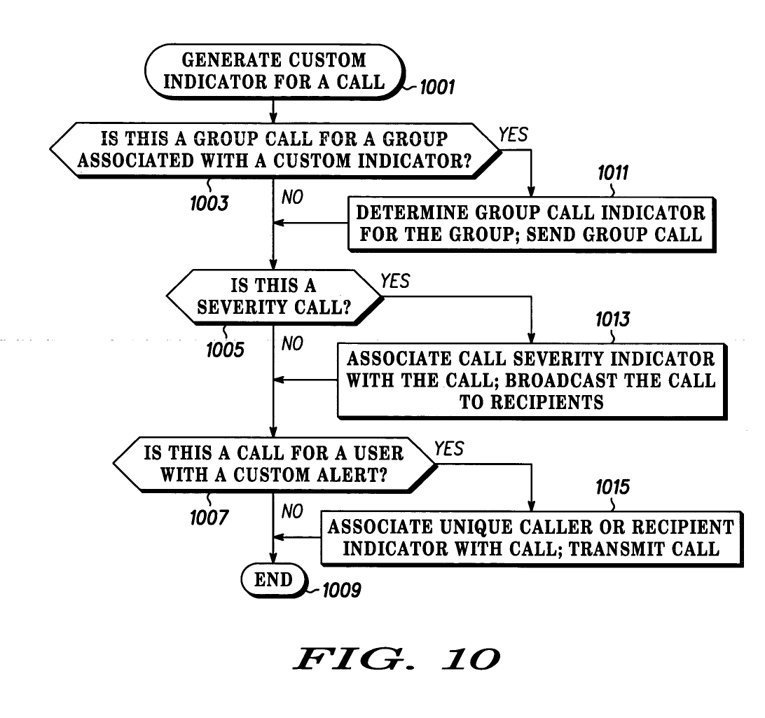

Reference is now made to FIG. 10, which illustrates an example flow chart for certain embodiments of fixed network equipment (FNE), herein represented by the antenna tower, to receive a call from a communication device, and to generate a custom indicator for a call, 1001. Having received the call or call request from the originator, the FNE determines which custom indicator to generate. At 1003, the FNE may determine whether the call is a group call for a group may be associated with a custom alert. If so, at 1011 the FNE can determine the group call indicator corresponding to the group and send the group call to the recipients. This may include a preliminary transmission of the group call indicator to the recipients. At 1005, the FNE determines whether the call is a severity call. If so, then at 1013, the FNE associates the call severity indicator with the call, and broadcasts the call to the recipients that receive severity calls. Various embodiments can provide for multiple types of severity calls. Optionally, the FNE may provide a preliminary transmission of the severity call indicator to the recipients. At 1007, the FNE determines whether the call is for a particular user (recipient or transmitter) with a custom alert. If so, at 1015, the FNE associates a unique caller or recipient indicator with the call, and transmits the call. Optionally, the FNE may provide a preliminary transmission of the unique caller or recipient indicator to the recipient. Processing for the FNE to generate a custom alert indicator for a call ends at 1009.

Certain embodiments can provide for a user to transmit a custom indicator to the network, e.g., a group call indicator for a group of listed users, a severity indicator, a unique caller indicator, and/or a unique recipient indicator. The transmitted custom indicator can be used later by the FNE.

According to one or more embodiments, the severity and status messages can be implemented as call alerts with a status ID other than zero. Currently, in an integrated digital enhanced radio system, a universal call notifier can be implemented as a “STATUS” with ID=0. The status identifiers can be provisioned in the Subscriber Identity Module (SIM). In order to send an emergency alert, or homeland security status, the handset can send a status with a predefined status identifier other than “0”.

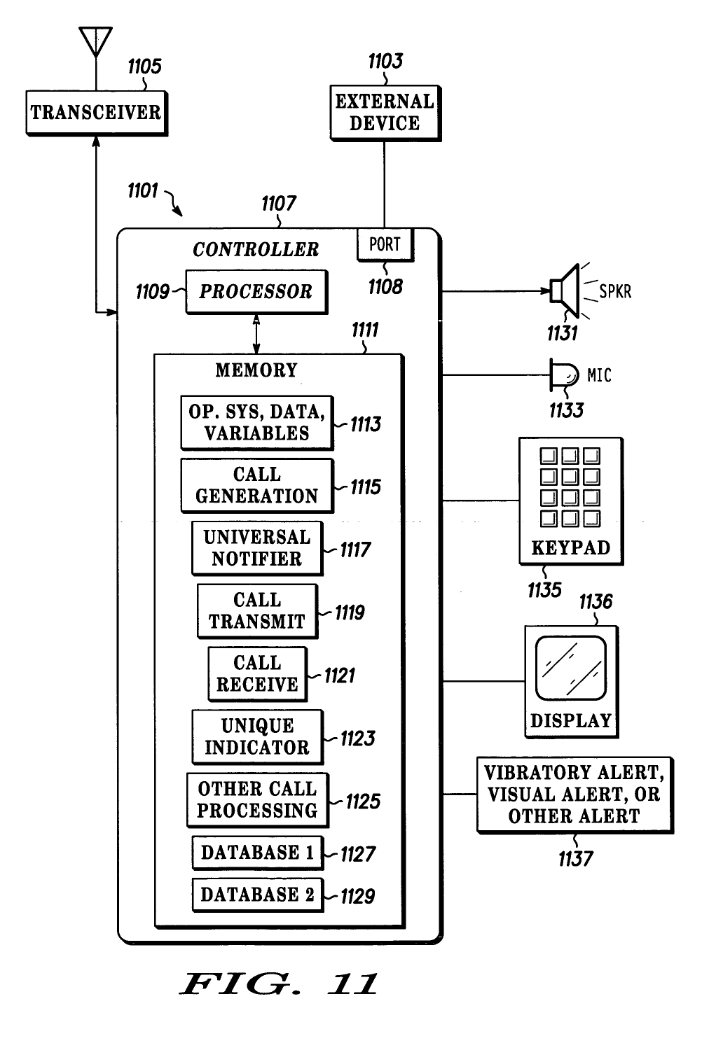

FIG. 11 is a block diagram of an exemplary communication device in accordance with one or more embodiments. The communication device 1101 includes a transceiver 1105 intercoupled to and controlled by a controller 1107 to support an air interface in accordance with known protocols and conventions. The controller 1107 includes a communications port 1108 for communication with an external device 1103 (e.g. SIM card or portable computer or the like), and a processor 1109 coupled to a memory 1111. The controller may include various other functionality, not specifically shown but generally known, such as various audio processing circuits and amplifiers. The controller 1107 is further shown coupled to an earpiece or speaker 1131, a microphone 1133, a user input device such as a keypad 1135, a display 1136, and another alerting device 1137. The alerting device can be used in addition to or in lieu of the speaker or display for providing, for example, a vibratory alert, visual alert (flashing led, etc), or other alert.

The processor 1109 may comprise one or more microprocessors and/or one or more digital signal processors. The memory 1111 may be coupled to the processor 1109 and may comprise some combination of read-only memory (ROM), random-access memory (RAM), programmable ROM (PROM), electrically erasable read-only memory (EEPROM), and the like. The memory 1111 includes multiple memory locations for storing, inter alia, an operating system, data and variables 1113 for programs executed by the processor 1109; computer programs for causing the processor to operate in connection with various functions such as a call generation function 1115, a universal notifier function 1117, a call transmit function 1119, a call receive function 1121, a unique indicator function 1123, and/or other call processing 1125; a database 1127 of various custom indicators; and a database 1129 for other information used by the processor 1109. The computer programs may be stored, for example, in ROM or PROM and may direct the processor 1109 in controlling the operation of the communication device 1101.

The processor 1109 can be programmed to alert the user of the communication device 1101 of the device's receipt of a call, by way of the speaker 1131, display 1136 or other alerting device 1137. The user alert can utilize a conventional vibration or audible alerting mechanism, visual alert, and/or other alert, or a combination thereof. The user may invoke functions accessible through the user input device 1135. The user input device 1135 may comprise one or more of various known input devices, such as a keypad, a computer mouse, a touchpad, a touch screen, a trackball, and/or a keyboard.

Responsive to signaling from the user input device 1135, in accordance with instructions stored in memory 1111, or automatically upon receipt of certain information via the transceiver 1105, the processor 1109 may direct the stored information or received information, such as a unique alert, as applicable, to be used to generate an alert. The display may present information to the user by way of a conventional liquid crystal display (LCD) or other visual display. The alert can be provided by way of a conventional audible device (e.g., the speaker 1131) for reproducing audible messages.

Accordingly a long standing problem has been advantageously solved, provided the concepts and principles described and discussed above are followed. In one or more of the above noted embodiments a widely recognized notifier or alert can still be employed to indicate a call or service availability or other circumstance using a notifier or alert and yet this notifier can be customized or individualized with an additional custom alert such that a user of the alert can distinguish the composite notifier or alert at their device from an alert for the same circumstances at other devices. Advantageously service providers or device suppliers can still reap the benefits of the good will associated with the widely recognized notifier, while the user enjoys a customized readily recognizable alert for the particular situation. This is in stark contrast to the teachings of prior art devices, where if the alert was allowed to be changed, the recognition provided by the standard alert for the service provider or goods supplier was given up.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended, and all equivalents thereof, when interpreted in accordance with the breadth to which they are fairly, legally, and equitably entitled.

What is claimed is:

1. A communication device comprising:
a transmitter for transmitting calls when operably connected to a network; and
a processor, coupled to the transmitter, wherein the processor is configured to facilitate generating a call to be transmitted to at least one recipient; determining a custom indicator associated with the call to individualize a universal notifier; associating the custom indicator with the call; and transmitting the call via the transmitter.

2. The device of claim 1, wherein the custom indicator is at least one of: a first indicator responsive to a severity level selected by one of the caller and the communication network; a second indicator associated with the caller; a third indicator associated with the at least one recipient; and a fourth indicator corresponding to at least one group of users with which the at least one recipient and the caller are associated.

3. The device of claim 2, wherein the processor is further configured to facilitate interacting with the user to determine the at least one group of users.

4. The device of claim 1, wherein the processor is further configured to facilitate interacting with the user to select the custom indicator to be associated with the call, and transmitting the custom indicator to the at least one recipient via the transmitter.

5. The device of claim 1, wherein the processor further is configured to facilitate interacting with the user to select a different custom indicator for use with one or more of a plurality of potential recipients.

6. The device of claim 1, wherein the processor further is configured to facilitate, in a group call having a plurality of recipients, designating a different custom indicator for at least one of the plurality of recipients.

7. The device of claim 1, wherein the call is a group call request, wherein the processor is further configured to facilitate transmitting a list of users and associated custom indicators for respective users in the group associated with the call.

8. A communication device comprising:
a receiver for receiving calls when operably coupled to a network;
a processor, coupled to the receiver, wherein the processor is configured to facilitate receiving a call; determining a universal notifier for the call; determining a custom indicator corresponding to the call; generating the universal notifier to the user indicating the presence of the call; and generating the custom identifier.

9. The device of claim 8, wherein the universal notifier corresponds to a status of the receiver when a communication channel over the network is clear to talk.

10. The device of claim 8, wherein the custom indicator is at least one of a first indicator responsive to a severity level selected by the caller or the network, a second indicator specific to the caller, a third indicator specific to the recipient, and a fourth indicator corresponding to at least one group of users with which the caller or the recipient is associated.

11. The device of claim 8, wherein the processor further is configured to facilitate interacting with the user to select at least one custom indicator to be associated with the call.

12. The device of claim 8, wherein the universal notifier is identified by a predefined status identifier in the call, and wherein the custom indicator associated with the call is implemented as a predefined status identifier other than the universal notifier.

13. The device of claim 8, wherein the receiver receives the custom indicator to be generated, and the processor is configured to facilitate storing the custom indicator.

14. The device of claim 8, wherein the universal notifier is specific to one of the provider of the network and a manufacturer of the device.

15. A controller for a communication messaging system, the controller comprising:
a communication interface for receiving calls including at least one call intended for at least one recipient;
a transmitter interface for transmitting the at least one call; and
a processor coupled to the communication interface, configured to facilitate receiving the at least one call via the communication interface, and at least one of:
(A) detecting whether the at least one call is a group call for a group associated with a custom indicator, and if so, associating a first indicator with the call; determining a plurality of recipients corresponding to the group; and transmitting the group call to the plurality of recipients, via the transmitter interface;
(B) detecting whether the at least one call is a severity call, and if so, associating a second indicator with the call; broadcasting the at least one call to a pre-defined plurality of recipients, via the transmitter interface; and
(C) detecting whether the at least one call is associated with a recipient or caller having a custom indicator, and if so, associating a third indicator with the call; and transmitting the at least one call, via the transmitter interface.

16. The controller of claim 15, wherein the processor further is configured to facilitate receiving an identification of the plurality of recipients corresponding to the group.

17. The controller of claim 15, wherein the processor further is configured to facilitate receiving at least one of the first indicator associated with the group, the second indicator to be associated with severity calls and the predefined plurality of recipients, and the third indicator to be associated with the recipient or caller.

18. A method for providing a universal notifier and a custom indicator in a communication device, comprising:
(A) receiving at least one call when the communication device is operably coupled to a network;
(B) determining a universal notifier for the call;
(C) determining, responsive to the at least one call, a custom indicator associated with the at least one call; and
(D) generating the universal notifier and the custom indicator, indicating the presence of the at least one call.

19. The method of claim 18, wherein the custom indicator is at least one of a first indicator responsive to a severity level selected by the caller or the network, a second indicator specific to the caller, a third indicator specific to the at least one recipient, and a fourth indicator corresponding to at least one group of users with which the at least one recipient and the caller are associated.

20. The method of claim 18, wherein the universal notifier is generated when a communication channel from the receiver over the network is clear to talk.
